(19) United States
(12) Patent Application Publication
(10) Pub. No.: US 2012/0134508 A1
(43) Pub. Date: May 31, 2012

(54) Audio Processing Apparatus

(75) Inventors: Takayuki Inoue, Hamamatsu-shi (JP); Hiroshi Saruwatari, Ikoma-shi (JP); Kazunobu Kondo, Hamamatsu-shi (JP)

(73) Assignees: Nara Institute of Science and Technology National University Corporation, Ikoma-shi (JP); YAMAHA CORPORATION, Hamamatsu-shi (JP)

(21) Appl. No.: 13/303,783

(22) Filed: Nov. 23, 2011

(30) Foreign Application Priority Data
Nov. 26, 2010 (JP) 2010-263204

(51) Int. Cl. H04B 15/00

(52) U.S. Cl. 381/94.1

(57) ABSTRACT

An audio processing apparatus generates a suppression coefficient sequence that is composed of coefficient values corresponding to frequency components of an audio signal, the frequency components being multiplied by the corresponding coefficient values to suppress noise components of the audio signal. In the audio processing apparatus, a characteristic value calculation unit calculates a noise characteristic value depending on a shape of a magnitude distribution of the audio signal. An intensity setting unit variably sets a suppression intensity of the noise components based on the noise characteristic value. A coefficient sequence generation unit generates the suppression coefficient sequence based on the audio signal and the suppression intensity.

### BACKGROUND OF THE INVENTION

1. Technical Field of the Invention

The present invention relates to a technology for suppressing a noise component in an audio signal.

2. Description of the Related Art

Techniques of suppressing a noise component in an audio signal derived from a mixed sound of a target component and the noise component have been proposed. For example, Japanese Patent Application publication No. 2004-53965 describes multiplication noise suppression that multiplies an audio signal by a spectrum gain (Wiener Filter) generated to suppress a noise component against a target component in a frequency domain.

However, in a technology for suppressing a noise component of an audio signal in a frequency domain, musical noise harsh to the ear is generated in the audio signal after suppression of the noise component. As a suppression intensity of the noise component increases, the musical noise becomes distinct. However, since conventional multiplication noise suppression does not consider a relationship between the suppression intensity and the amount of generation of the musical noise, it is difficult to effectively suppress the musical noise while securing a desired noise reduction rate.

### SUMMARY OF THE INVENTION

In view of this, an object of the present invention is to appropriately set a suppression intensity of a noise component in the multiplication noise suppression.

The invention employs the following means in order to achieve the object. Although, in the following description, elements of the embodiments described later corresponding to elements of the invention are referenced in parentheses for better understanding, such parenthetical reference is not intended to limit the scope of the invention to the embodiments.

An audio processing apparatus of a first aspect of the invention generates a suppression coefficient sequence (for example, a suppression coefficient sequence G(τ)) that is used for noise reduction of an audio signal and that is composed of coefficient values corresponding to frequency components of the audio signal, the frequency components being multiplied by the corresponding coefficient values to suppress noise components of the audio signal. The inventive audio processing apparatus comprises: a characteristic value calculation unit (for example, a characteristic value calculator 46) that calculates a noise characteristic value (for example, a shape parameter α) depending on a shape of a magnitude distribution of the audio signal; an intensity setting unit (for example, an intensity setting unit 48) that variably sets a suppression intensity (for example, a suppression intensity β) of the noise components based on the noise characteristic value; and a coefficient sequence generation unit (for example, a coefficient sequence generator 44) that generates the suppression coefficient sequence based on the audio signal and the suppression intensity.

In this configuration, the suppression intensity of multiplication noise suppression is varied depending on the noise characteristic value that represents the shape of the magnitude distribution of the audio signal. Accordingly, this configuration has an advantage in that a suppression coefficient sequence capable of implementing appropriate noise suppression for the audio signal having various characteristics can be generated.

For example, the intensity setting unit sets the suppression intensity such that a rate of the noise reduction achieved by applying the suppression coefficient sequence to the audio signal exceeds a target value (for example, a target value Rtar) and such that a kurtosis index representing a degree of variation in kurtosis of the magnitude distribution of the audio signal before and after the noise reduction is lower than an allowable value (for example, an allowable value κtar). Practically, the intensity setting unit sets a plurality of candidates of the suppression intensity, then calculates a vector composed of the rate of the noise reduction and the kurtosis index for each candidate of the suppression intensity, further calculates a similarity between each vector of each candidate and a reference vector composed of the target value of the rate of the noise reduction and the allowable value of the kurtosis index, and sets a candidate having a maximum similarity to the the suppression intensity among the plurality of the candidates of the suppression intensity.

According to this aspect, it is possible to generate a suppression coefficient sequence that can improve noise suppression performance (noise reduction rate R) to a high level while reducing musical noise.

The audio processing apparatus according to the first aspect of the invention further comprises a condition designation unit (for example, a condition designation unit 60) that variably sets the target value of the rate of the noise reduction and the allowable value of the kurtosis index. For example, the condition designation unit variably sets the target value and allowable value based on an instruction from a user. This aspect has an advantage in that it is possible to variably set noise suppression performance (noise reduction rate) to which the suppression coefficient sequence is applied and a degree by which musical noise caused by noise suppression is reduced.

An audio processing apparatus according to a second aspect of the invention generates a suppression coefficient sequence that is composed of coefficient values corresponding to frequency components of an audio signal, the frequency components being multiplied by the corresponding coefficient values so as to suppress noise components of the audio signal. The inventive audio processing apparatus comprises: a noise estimation unit (for example, a noise estimation unit 42) that estimates the noise components of the audio signal; a coefficient sequence generation unit (for example, a coefficient sequence generator 44) that calculates each coefficient value g(f) of the suppression coefficient sequence corresponding to each frequency if of the frequency components of the audio signal using the following Equation (A)

g(f)={|X(f)|^{ξ}/(|X(f)|^{ξ}+β·Et[|N(f)|^{ξ}])}^{η} (A)

where |X(f)| denotes an amplitude at a corresponding frequency f of the audio signal, |N(f)| denotes an estimated amplitude at the corresponding frequency f of the estimated noise component of the audio signal, Et[ ] denotes a time average, β denotes a suppression intensity, ξ denotes a signal exponent of a positive number, and η denotes a gain exponent of a positive number; and an exponent setting unit (for example, an exponent setting unit 62) that sets the signal exponent ξ and the gain exponent η to different numbers.

According to the audio processing apparatus of the second aspect of the invention, since the signal exponent ξ and the gain exponent η are set to different values (positive numbers), it is possible to improve noise suppression performance while reducing musical noise by appropriately selecting the signal exponent ξ and the gain exponent η.

The characteristic value calculation unit and the intensity setting unit of the audio processing apparatus in accordance with the first aspect of the invention may be added to the audio processing apparatus in accordance with the second aspect of the invention. The characteristic value calculation unit calculates a noise characteristic value of the audio signal and the intensity setting unit sets the suppression intensity β of Equation (A) such that the suppression intensity β varies with the noise characteristic value. The coefficient sequence generation unit calculates each coefficient value g(f) of the suppression coefficient sequence through Equation (A) to which the suppression intensity β set by the intensity setting unit is applied. According to this configuration, the same effect as that of the audio processing apparatus of the first aspect of the invention can be achieved.

There is a tendency that a degree by which the kurtosis index is reduced and a degree by which the noise reduction rate is improved become higher as the signal exponent ξ and the gain exponent η of Equation (A) become smaller. Therefore, according to a preferred embodiment of the second aspect of the invention, at least one of the signal exponent ξ and the gain exponent η is set to a small value (for example, a value smaller than 1). For example, the signal exponent ξ can be set to a positive number smaller than 1 (or preferably a value equal to or smaller than 0.5) and the gain exponent η can be set to a value different from the signal exponent Furthermore, at least one of the signal exponent ξ and the gain exponent η may be set to a minimum value within a range of calculation capability of the audio processing apparatus (arithmetic processing device).

In addition, an audio processing apparatus according to a preferred embodiment of the second aspect of the invention includes an exponent setting unit (for example, an exponent setting unit 62) that variably sets at least one of the signal exponent ξ and the gain exponent η of Equation (A) to a variable value. This embodiment has an advantage in that the signal exponent ξ and the gain exponent η can be adjusted depending on various conditions (for example, calculation capability of the audio processing apparatus, etc.) such that noise suppression performance is enhanced while musical noise is reduced (for example, such that the noise reduction rate R exceeds the target value Rtar and the kurtosis index κ is lower than the allowable value κ tar).

The audio processing apparatus according to each of the above aspects may be implemented by hardware (electronic circuitry) such as DSP (Digital Signal Processor) dedicated for generation of the suppression coefficient sequence but may also be implemented through cooperation of a general-purpose arithmetic processing device with a program (software).

A program according to a first aspect executes, on a computer, a characteristic value calculation process for calculating a noise characteristic value depending on a shape of an audio signal magnitude distribution, an intensity setting process for setting a suppression intensity of a noise component such that the suppression intensity varies with the noise characteristic value, and a coefficient sequence generation process for generating a suppression coefficient sequence based on the audio signal and the suppression intensity, thereby generating the suppression coefficient sequence that is composed of coefficient values of frequencies respectively multiplied by frequency components of the audio signal and suppresses the noise components of the audio signal. According to this program, the same operation and effect as those of the audio processing apparatus according to the first aspect are achieved.

A program of a second aspect of the invention executes, on a computer, a noise estimation process for estimating a noise component of an audio signal, a coefficient sequence generation process for calculating a suppression coefficient sequence that is composed of coefficient values of frequencies respectively multiplied by frequency components of the audio signal and suppresses the noise component of the audio signal using Equation (A), and an exponent setting process of setting the signal exponent ξ and the gain exponent η to different numbers. According to this program, the same operation and effect as those of the audio processing apparatus according to the second aspect are achieved.

The program according to the first aspect or second aspect may be provided to a user through a computer readable storage medium storing the program and then installed on a computer and may also be provided from a server device to a user through distribution over a communication network and then installed on a computer.

### BRIEF DESCRIPTION OF THE DRAWINGS

FIG. 1 is a block diagram of an audio processing apparatus according to a first embodiment of the invention.

FIG. 2 shows a variable table.

FIG. 3 is a graph showing a relationship between a noise reduction rate and a kurtosis index for multiplication noise suppression and spectral subtraction.

FIG. 4 is a graph showing a relationship between a noise reduction rate and a kurtosis index in a plurality of cases where a signal exponent and a gain exponent are different from each other.

FIG. 5 is a block diagram of a noise suppression analysis apparatus.

FIG. 6 is a flowchart illustrating an operation of a variable analyzer.

FIG. 7 is a block diagram of an audio processing apparatus according to a second embodiment of the invention.

FIG. 8 is a flowchart illustrating an operation of a second processor according to the second embodiment of the invention.

FIG. 9 is a block diagram of an audio processing apparatus according to a third embodiment of the invention.

FIG. 10 is a block diagram of an audio processing apparatus according to a fourth embodiment of the invention.

### DETAILED DESCRIPTION OF THE DRAWINGS

### A: First Embodiment

<Audio Processing Apparatus>

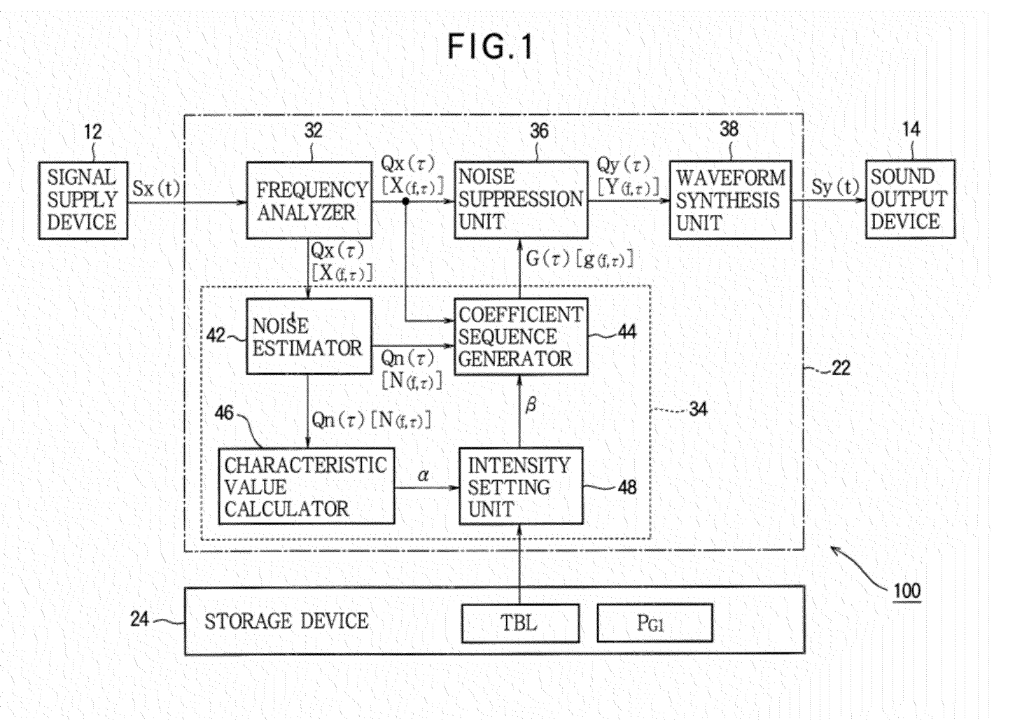

FIG. 1 is a block diagram of an audio processing apparatus 100 according to a first embodiment of the invention. A signal supply device 12 and a sound output device 14 are connected to the audio processing apparatus 100. The signal supply device 12 supplies an audio signal Sx(t) to the audio processing apparatus 100. The audio signal Sx(t) is a time domain signal (t: time) representing a waveform of a mixed sound of a target sound component s(t) (for example, a sound component such as voice or music) and a noise component n(t), as represented by the following Equation (1).

Sx(t)=s(t)+n(t) (1)

It is possible to employ, as the signal supply device 12, a sound receiving device that receives surrounding sound and generates the audio signal Sx(t), a reproduction device that obtains the audio signal Sx(t) from a portable or built-in recording medium and supplies the audio signal Sx(t) to the audio processing apparatus 100, or a communication device that receives the audio signal Sx(t) from a communication network and supplies the audio signal Sx(t) to the audio processing apparatus 100.

The audio processing apparatus 100 is a noise suppression apparatus that generates an audio signal Sy(t) by suppressing the noise component n(t) of the audio signal Sx(t) supplied from the signal supply device 12 (emphasizing the target sound component s(t)). The sound output device 14 (for example, a speaker, a headphone, etc.) reproduces sound waves on the basis of the audio signal Sy(t) generated by the audio processing apparatus 100. A D/A converter for converting the audio signal Sy(t) from a digital signal to an analog signal is not shown for convenience.

As shown in FIG. 1, the audio processing apparatus 100 is implemented as a computer system including an arithmetic processing device 22 and a storage device 24. The storage device 24 stores a program PG1 executed by the arithmetic processing device 22 and various information items (for example, a variable table TBL which will be described below) used by the arithmetic processing device 22. A known recording medium such as a semiconductor storage device or a magnetic storage medium or a combination of a plurality of types of recording media may be arbitrarily used as the storage device 24. A configuration in which the audio signal Sx(t) is stored in the storage device 24 may be employed (accordingly, the signal supply device 12 is omitted).

The arithmetic processing device 22 implements a plurality of functions (a frequency analyzer 32, an analysis processor 34, a noise suppression unit 36, and a waveform synthesis unit 38) for generating the audio signal Sy(t) from the audio signal Sx(t) by executing the program PG1 stored in the storage device 24. It is possible to employ a configuration in which each function of the arithmetic processing device 22 is divided into a plurality of integrated circuits and a configuration in which a dedicated electronic circuit (DSP) executes each function of the arithmetic processing device 22.

The frequency analyzer 32 sequentially generates frequency spectrum Qx(τ) of the audio signal Sx(t) for each unit interval (frame) on the time axis. A symbol τ represents the number of a unit interval. The frequency spectrum Qx(τ) is a complex spectrum represented as a plurality of frequency components corresponding to different frequencies (frequency bands) f. A known frequency analysis method, for example, short-time Fourier transform can be arbitrarily employed to generate the frequency spectrum Qx(τ).

The analysis processor 34 generates a suppression coefficient sequence G(τ) for suppressing the noise component n(t) of the audio signal Sx(t) for each unit interval. The suppression coefficient sequence G(τ) is series of a plurality of coefficient values g(f, τ) corresponding to different frequencies f. Each coefficient value g(f, τ) means a gain (spectrum gain) for a frequency component X(f, τ) of the audio signal Sx(t) and is variably set in a range of 0 to 1 based on the characteristic of the noise component n(t). Specifically, the coefficient value g(f, τ) is set to a value as small as a coefficient value g(f, τ) of a frequency f at which the intensity of the noise component n(t) is high in the audio signal Sx(t).

The noise suppression unit 36 shown in FIG. 1 applies (typically multiplies) the suppression coefficient sequence G(τ) generated by the analysis processor 34 to the frequency spectrum Qx(τ) of the audio signal Sx(t) so as to sequentially generate frequency spectrum Qy(τ) of the audio signal Sy(t) for each unit interval. Specifically, each frequency component Y(f, τ) of the frequency spectrum Qy(τ) is calculated by multiplying the frequency component X(f, τ) of the frequency spectrum Qx(τ) of each unit interval by the coefficient value g(f, τ) of the suppression coefficient sequence G(τ) of each unit interval, as represented by the following Equation (2). Accordingly, the frequency spectrum Qy(τ) in which the noise component n(t) of the audio signal Sx(t) has been suppressed is generated.

Y(f,τ)=g(f,τ)·X(f,τ) (2)

The waveform synthesis unit 38 generates the audio signal Sy(t) of the time domain from the frequency spectrum Qy(τ) generated by the noise suppression unit 36 for each unit interval. Specifically, the waveform synthesis unit 38 transforms the frequency spectrum Qy(τ) of each unit interval into a time domain through inverse Fourier transform and connects unit intervals before and after the corresponding unit interval to generate the audio signal Sy(t). The audio signal Sy(t) generated by the waveform synthesis unit 38 is supplied to the sound output device 14 and reproduced as sound waves.

<Analysis Processor 34>

The analysis processor 34 is described. As shown in FIG. 1, the analysis processor 34 includes a noise estimator 42, a coefficient sequence generator 44, a characteristic value calculator 46, and an intensity setting unit 48.

The noise estimator 42 estimates each frequency spectrum Qn(τ) (complex spectrum specified by a frequency component N(f, τ) of each frequency f) of the noise component n(t) included in the audio signal Sx(t). A known technology may be arbitrarily employed to estimate the noise component n(t). Specifically, the noise estimator 42 divides the audio signal Sx(t) into a target sound period in which the target sound component s(t) is present and a noise period in which the target sound component s(t) is not present, and specifies the frequency spectrum Qx(τ) of each unit interval in the noise period as the frequency spectrum Qn(τ) of the noise component n(t) (N(f, τ)=X(f, τ)). A known voice activity detection (VAD) is arbitrarily employed to discriminate the target sound period and the noise period from each other.

The coefficient sequence generator 44 sequentially generates the suppression coefficient sequence G(τ) for each unit interval. Specifically, the coefficient sequence generator 44 calculates each coefficient value g(f, τ) of the suppression coefficient sequence G(τ) using the following Equation (3) which includes the amplitude |X(f,τ)| of the audio signal Sx(t) and the amplitude |N(f,τ)| of the noise component n(t) (that is, amplitude |X(f,τ)| in the noise period).

$$g ( f , τ ) = {b ( f , τ )}^{η} = {( \frac{{\vert X ( f , τ ) \vert}^{ξ}}{{\vert X ( f , τ ) \vert}^{ξ} + β \cdot Et [ {\vert N ( f , τ ) \vert}^{ξ} ]} )}^{η} \qquad ( 3 )$$

A symbol Et[ ] in Equation (3) denotes calculation of an expected value (for example, a time average over a plurality of unit time intervals in the noise period). A symbol ξ denotes an exponent (hereinafter referred to as a signal exponent) for the amplitude |X(f,τ)| and the amplitude |N(f,τ)|, and a symbol η means an exponent (hereinafter referred to as a gain exponent) for a basic value b(f, τ) ((b(f, τ)=|X(f,τ)|^{ξ}/(|X(f,τ)|^{ξ}+βEt[|N(f,τ)|^{ξ}]) based on the amplitude |X(f,τ)| and amplitude |N(f,τ)|. The signal exponent ξ and the gain exponent η are positive numbers. That is, the suppression coefficient sequence G(τ) composed of coefficient values g(f, τ) of Equation 3 corresponds to a Wiener filter that generalizes the signal exponent ξ and the gain exponent η.

As is understood from Equation (3), the coefficient value g(f, τ) is set to a smaller value (a value that suppresses the frequency component X(f, τ) of the audio signal Sx(t) according to the operation of the noise suppression unit 36) as a variable β becomes larger when the amplitude |N(f,τ)| of the noise component n(T) is fixed. That is, the variable β of Equation (3) corresponds to a case of noise suppression using the suppression coefficient sequence G(τ) (hereinafter referred to as a suppression intensity). The characteristic value calculator 46 and the intensity setting unit 48 shown in FIG. 1 variably set the suppression intensity β.

The characteristic value calculator 46 calculates a shape parameter α based on the characteristic of the noise component n(t) of the audio signal Sx(t) from the frequency spectrum Qn(τ) of the noise component n(t). The shape parameter α is a statistic based on a shape of a frequence distribution (hereinafter referred to as a magnitude distribution) of the power |X(f,τ)|² of the audio signal Sx(t) (that is, the power |N(f,τ)|² of the noise component n(t)) over a plurality of unit intervals in the noise period. The shape parameter α varies according to the property (type) of the noise component n(t). For example, the shape parameter α becomes a larger value as Gaussian property of the noise component n(t) becomes higher.

The characteristic value calculator 46 according to the first embodiment of the invention calculates a shape parameter α of a probability distribution D1 that approximates the magnitude distribution of the audio signal Sx(t). The probability distribution D1 that approximates the magnitude distribution of the audio signal Sx(t) (noise component n(t)) may be a gamma distribution, for example. The gamma distribution is represented by a probability density function P(x) of Equation (4) having the power x (x=|X(f,τ)|²) of the audio signal Sx(t) as a random variable.

$$P ( x ) = \frac{{x}^{α - 1}}{Γ ( α ) {θ}^{α}} exp ( - \frac{x}{θ} ) \qquad ( 4 )$$

A shape parameter α in Equation (4) is calculated by the following Equations (5A) and (5B), and a scaling parameter ⊖ is calculated by the following Equation (5C). A symbol Γ(α) of Equation (4) denotes a gamma function defined by the following Equation (6). The characteristic value calculator 46 calculates the shape parameter a through Equations (5A) and (5B) using the power |X(f,τ)|² of the audio signal Sx(t) (that is, the power |N(f,τ)² of the noise component n(t)) in the noise period as a random variable x.

$$\begin{matrix}α = \frac{3 - γ + \sqrt{{( γ - 3 )}^{2} + 24 γ}}{12 γ} & ( 5 A ) \\ γ = log ( Et [ x ] ) - Et [ log ( x ) ] & ( 5 B ) \\ θ = \frac{Et [ x ]}{α} & ( 5 C ) \\ Γ ( α ) = {\int }_{0}^{∞} {t}^{α - 1} exp ( - t ) d t & ( 6 )\end{matrix}$$

The intensity calculator 48 shown in FIG. 1 variably sets the suppression intensity β applied by the coefficient sequence generator 44 to generation of the suppression coefficient sequence G(τ) depending on the shape parameter α calculated by the characteristic value calculator 46. A variable table TBL stored in the storage device 24 is used to set the suppression intensity β.

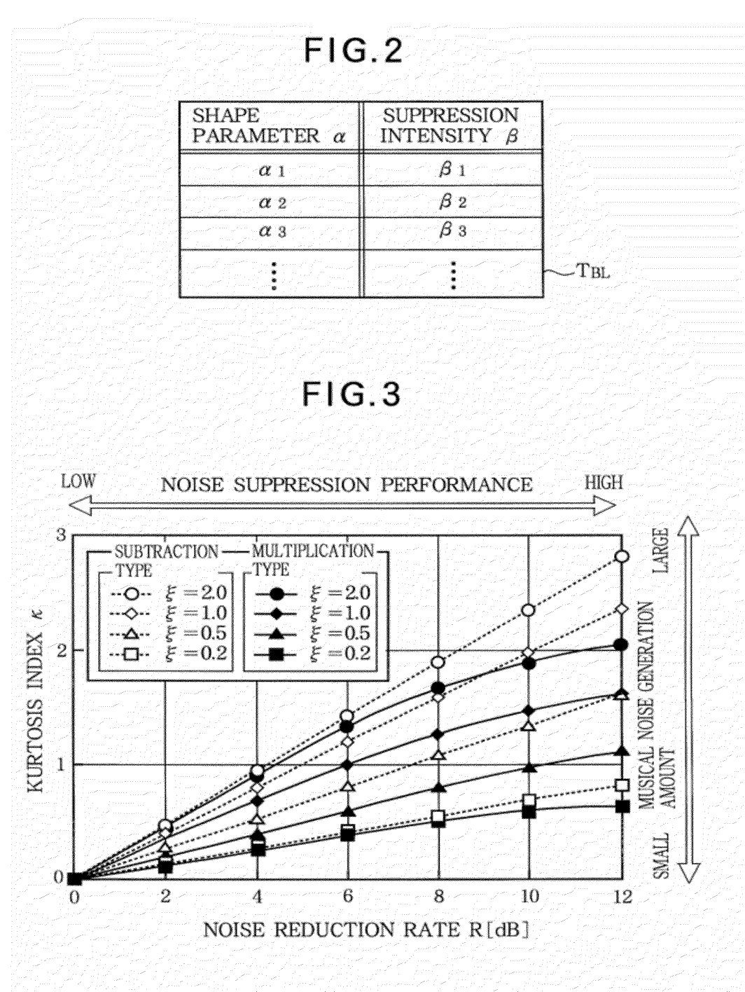

FIG. 2 shows a variable table TBL. As shown in FIG. 2, the variable table TBL is a data table in which values α1, α2, . . . of the shape parameter α respectively correspond to values β1, β2, . . . of the suppression intensity β. The intensity setting unit 48 searches the variable table TBL for a value of the suppression intensity β corresponding to the shape parameter α calculated by the characteristic value calculator 46 and informs the coefficient sequence generator 44 of the searched suppression intensity β. The coefficient sequence generator 44 calculates each coefficient value g(f, τ) of the suppression coefficient sequence g(τ) through Equation (3) to which the suppression intensity β informed by the intensity setting unit 48 is applied, as described above. As is understood from the above description, the suppression intensity β is variably controlled depending on the characteristic of the audio signal Sx(t) (specifically, noise component n(t)).

There is a possibility that high-intensity components (isolated points) are scattered on the time axis and frequency axis in the frequency spectrum Qy(τ) generated according to noise suppression of Equation (2) and an observer perceives the high-intensity components as musical noise artificially harsh to the ear. The musical noise becomes distinct as the suppression intensity β increases. In addition, a noise reduction rate (noise suppression performance) increases as the suppression intensity β increases. In consideration of this tendency, a value of the suppression intensity β corresponding to each value of the shape parameter α in the variable table TBL is analytically set such that compatibility of improvement in the noise reduction rate with reduction in the musical noise is achieved.

<Analysis of Action of Noise Suppression>

It is necessary to estimate the noise reduction rate and the amount of generation of musical noise quantitatively in order to create the variable table TBL that satisfies the above condition. Accordingly, the action of suppression processing of Equation (2) is analyzed to formulate the noise reduction rate and the amount of generation of musical noise in the following.

It is noted that the probability distribution D1 represented by the probability density function P(x) of the random variable x (x=|X(f,τ)|²) is changed to a probability distribution D2 through noise suppression of Equation (2). The probability distribution D2 is represented as a probability density function P(y) having power y (y=|Y(f,τ)|²) of a frequency component Y(f, τ) after the noise suppression as a random variable. If mapping q (y=q(x)) of the random variable x to a random variable y is considered, the probability density function P(y) after the noise suppression is represented by the following Equation (7).

P(y)=P(q⁻¹(y))|J| (7)

A symbol |J| in Equation (7) denotes Jacobian defined by the following Equation (8).

$$\vert J \vert = \vert \frac{\partial {q}^{- 1}}{\partial y} \vert \qquad ( 8 )$$

When Equation (3) is applied to Equation (2), the following Equation (9) is derived.

$$Y ( f , τ ) = {( \frac{{\vert X ( f , τ ) \vert}^{ξ}}{{\vert X ( f , τ ) \vert}^{ξ} + β \cdot Et [ {\vert N ( f , τ ) \vert}^{ξ} ]} )}^{η} X ( f , τ ) \qquad ( 9 )$$

When both sides of Equation (9) are squared, Equation (10) is derived. In deriving Equation (10), the phase angle of the frequency component X(f, τ) was ignored for convenience.

$${\vert Y ( f , τ ) \vert}^{2} = {( \frac{{\vert X ( f , τ ) \vert}^{ξ}}{{\vert X ( f , τ ) \vert}^{ξ} + β \cdot Et [ {\vert N ( f , τ ) \vert}^{ξ} ]} )}^{2 η} {\vert X ( f , τ ) \vert}^{2} \qquad ( 10 )$$

An expected value Et[|N(f,τ)|^{ξ}] is represented by Equation (11). Equation (11) is described in, for example, T. Inoue, et al., “Theoretical analysis of musical noise in generalized spectral subtraction: why should not use power/amplitude subtraction?”, Proc. EUSIPCO2010, p. 994-998, 2010.

$$Et [ {\vert N ( f , τ ) \vert}^{ξ} ] = {θ}^{\frac{ξ}{2}} Γ ( α + \frac{ξ}{2} ) / Γ ( α ) \qquad ( 11 )$$

The random variable x corresponds to the power |X(f,τ)|² of the frequency component X(f, τ) and the random variable y corresponds to the power |Y(f,τ)|² of the frequency component Y(f, τ). Accordingly, Equation (12) that represents the random variable y is derived from Equation (10).

$$y = {\{ \frac{{x}^{\frac{1}{2} ( ξ + \frac{1}{η} )}}{{x}^{\frac{ξ}{2}} + β {θ}^{\frac{ξ}{2}} Γ ( α + \frac{ξ}{2} ) / Γ ( α )} \}}^{2 η} \qquad ( 12 )$$

Since Equation (12) is a monotone function, an inverse function x=f(y) exists. In addition, the variables x and y are all positive numbers (x>0, y>0), and thus Jacobian |J| of Equation (8) is represented by Equation (13).

$$\frac{d x}{d y} = {f}^{′} ( y ) = \vert J \vert \qquad ( 13 )$$

Accordingly, the probability density function P(y) of Equation (7) is represented by the following Equation (14) using the relationship between Equation (4) and Equation (13).

$$P ( y ) = P ( x ) \vert J \vert = \frac{{( f ( y ) )}^{α - 1} exp ( \frac{- f ( y )}{θ} )}{Γ ( α ) {θ}^{α}} {f}^{′} ( y ) \qquad ( 14 )$$

<M-th Order Moment μm of Probability Density Function P(y)>

An m-th order central moment μm of the probability density function P(y) of Equation (14) is described. The m-th order moment μm is represented by the following Equation (15).

$$\begin{matrix}{μ}_{m} = {\int }_{0}^{∞} {y}^{m} P ( y ) d y = \\ = {\int }_{0}^{∞} {y}^{m} \frac{{( f ( y ) )}^{α - 1} exp ( \frac{- f ( y )}{θ} )}{Γ ( α ) {θ}^{α}} {f}^{′} ( y ) d y\end{matrix} \qquad ( 15 )$$

When a variable f(y)/⊖ of Equation (15) is substituted with a variable t, the following Equation (16) and Equation (17) are obtained.

$$d y = \frac{θ}{{f}^{′} ( y )} d t \qquad ( 16 )$$

f(y)=θt=x (17)

When Equation (17) is applied to Equation (12), the following Equation (18) is derived.

$$\begin{matrix}{y}^{m} = {\{ \frac{{( θ t )}^{\frac{1}{2} ( ξ + \frac{1}{η} )}}{{( θ t )}^{\frac{ξ}{2}} + β {θ}^{\frac{ξ}{2}} Γ ( α + \frac{ξ}{2} ) / Γ ( α )} \}}^{2 m η} \\ = \frac{{θ}^{m} {t}^{( ξ η + 1 ) m}}{{\{ {t}^{\frac{ξ}{2}} + β \cdot Γ ( α + \frac{ξ}{2} ) / Γ ( α ) \}}^{2 m η}}\end{matrix} \qquad ( 18 )$$

The following Equation (19) that represents the m-th order moment μm of the probability density function P(y) is derived by applying Equations (16), (17) and (18) to Equation (15). A function M(α, β, m, ξ, η) of Equation (19) is defined by the following Equation (20).

$$\begin{matrix} {μ}_{m} = \frac{{θ}^{m}}{Γ ( α )} M ( α , β , m , ξ , η ) & ( 19 ) \\ M ( α , β , m , ξ , η ) = {\int }_{0}^{∞} \frac{{t}^{( ξ η + 1 ) m + α - 1}}{{\{ {t}^{\frac{ξ}{2}} + β \cdot Γ ( α + \frac{ξ}{2} ) / Γ ( α ) \}}^{2 m η}} exp ( - t ) d t & ( 20 )\end{matrix}$$

<Musical Noise Generation>

In view of the fact that musical noise caused by noise suppression is a non-Gaussian sound component, a high-order statistic corresponding to a Gaussian index of a magnitude distribution is used as a quantitative index of the quantity of generation of musical noise. Specifically, kurtosis of a magnitude distribution (a probability distribution that approximates a magnitude distribution) may be used as an index of the quantity of generation of musical noise. That is, it can be considered that musical noise becomes distinct as a kurtosis variation during a noise suppression process becomes higher. Accordingly, a kurtosis index K that represents a variation in the kurtosis of the magnitude distribution in the noise suppression process is used as an index of the quantity of generation of musical noise in the following description.

Specifically, the kurtosis index K is a relative ratio (κ=KB/KA) of kurtosis KB after noise suppression to kurtosis KA before the noise suppression. That is, it can be considered that musical noise becomes distinct as the kurtosis index κ increases. A relationship between the kurtosis index κ and musical noise is described in Uemura Masunaga, et al., “Relationship between logarithmic kurtosis ratio and degree of musical noise generation on spectral subtraction”, Institute of Electronics, information and communication engineers, technical research reports, Applied Acoustic, Institute of Electronics, information and communication engineers, 108(143) p. 43-48, 11^{th} of July, 2008. A relative ratio of the algebraic value of the kurtosis KA to the algebraic value of the kurtosis KB or a difference between the kurtosis KA and kurtosis KB may be used as the kurtosis index κ. Further, the copending U.S. patent application Ser. No. 12/782,615 describes the kurtosis index κ in more detail. All contents of the copending U.S. patent application Ser. No. 12/782,615 is incorporated in this specification.

Since kurtosis K of a magnitude distribution is defined as a relative ratio μ4/μ2² of fourth order moment μ4 to the square of second order moment μ2, the kurtosis K is represented by the following Equation (21) using the m-th order moment μm of Equation (19).

$$\begin{matrix}K = \frac{{μ}_{4}}{{μ}_{2}^{2}} \\ = \{ \frac{{θ}^{4}}{Γ ( α )} M ( α , β , 4 , ξ , η ) \} / {\{ \frac{{θ}^{2}}{Γ ( α )} M ( α , β , 2 , ξ , η ) \}}^{2} \\ = Γ ( α ) \cdot M ( α , β , 4 , ξ , η ) / {M}^{2} ( α , β , 2 , ξ , η )\end{matrix} \qquad ( 21 )$$

Equation (21) represents the kurtosis KB of the magnitude distribution after noise suppression of the suppression intensity β. The kurtosis KA of the magnitude distribution before the noise suppression corresponds to kurtosis K (Γ(α)·M(α, 0, 4, ξ, η)/M²(α, 0, 2, ξ, η)) in the case where the suppression intensity β is zero in Equation (21). Accordingly, the kurtosis index κ corresponding to the relative ratio of the kurtosis KA to the kurtosis KB is represented by the following Equation (22).

$$k = \frac{KB}{KA} = \frac{M ( α , β , 4 , ξ , η ) / {M}^{2} ( α , β , 2 , ξ , η )}{M ( α , 0 , 4 , ξ , η ) / {M}^{2} ( α , 0 , 2 , ξ , η )} \qquad ( 22 )$$

<Noise Reduction Rate>

A noise reduction rate R that becomes a noise suppression performance index in Equation (2) is described. The noise reduction rate R is a difference between a signal-to-noise (SN) ratio after noise suppression and a SN ratio before noise suppression and is defined by the following Equation (23).

$$R = 10 {log}_{10} \frac{Et [ {s}_{OUT} ] / Et [ {n}_{OUT} ]}{Et [ {s}_{I N} ] / Et [ {n}_{I N} ]} \qquad ( 23 )$$

A symbol s in Equation (23) denotes the power of the target sound component s(n) and a symbol n denotes the power of the noise component n(t). A subscript IN means a state before noise suppression and a subscript OUT means a state after noise suppression. That is, the denominator of Equation (23) corresponds to the SN ratio before noise suppression and the numerator of Equation (23) corresponds to the SN ratio after noise suppression.

If the amount of suppression of the noise component n(t) according to noise suppression is sufficiently greater than the amount of suppression of the target sound component s(t), a variation in the target sound component s(t) during the noise suppression process can be ignored approximately, and thus Equation (23) is approximated as the following Equation (24).

$$R = 10 {log}_{10} \frac{Et [ {n}_{I N} ]}{Et [ {n}_{OUT} ]} \qquad ( 24 )$$

An expected value (mean value) Et[n_{OUT}] of the noise component n(t) after noise suppression in Equation (24) corresponds to first order moment μ1 obtained by setting a variable m in Equation (19) to 1. An expected value Et[n_{IN}] of the power of the noise component n(t) before the noise suppression corresponds to first order moment μ1 of the probability density function P(y) when the suppression intensity β is set to 0. Accordingly, Equation (24) is modified into the following Equation (25).

$$R = 10 {log}_{10} \frac{M ( α , 0 , 1 , ξ , η )}{M ( α , β , 1 , ξ , η )} \qquad ( 25 )$$

<Relationship Between Kurtosis Index κ and Noise Reduction Rate R>

FIG. 3 is a graph (solid line) showing a relationship between the kurtosis index κ and noise reduction rate R of Equation (22). FIG. 3 shows a relationship between the kurtosis index κ and noise reduction rate R for a plurality of cases (ξ=2.0, 1.0, 0.5, 0.2) in which the signal exponent ξ of the suppression coefficient sequence G(τ) is varied. The gain exponent η of Equation (3) is set to the inverse number (η=1/ξ) of the signal exponent ξ. FIG. 3 also shows a relationship (dashed line) between the kurtosis index κ and noise reduction rate R when spectral subtraction represented by the following Equation (26A) and Equation (26B) is performed for a plurality of cases in which the exponent ξ of Equation (26A) is varied for comparison with multiplication noise suppression represented by Equation (2). Noise (Gaussian noise) having a shape parameter α of 1 is considered as the audio signal Sx(t) for any of multiplication noise suppression and spectral subtraction.

$$\vert Y ( f , τ ) \vert = \{ \begin{matrix}\sqrt[ξ]{{\vert X ( f , τ ) \vert}^{ξ} - ϕ \cdot Et [ {\vert N ( f , τ ) \vert}^{ξ} ]} \\ ( if {\vert X ( f , τ ) \vert}^{ξ} - ϕ \cdot Et [ {\vert N ( f , τ ) \vert}^{ξ} ] > 0 ) \\ 0 ( otherwise )\end{matrix} \qquad \begin{matrix}( 26 A ) \\ ( 26 B )\end{matrix}$$

When the suppression intensity β of Equation (3) and a subtraction coefficient φ of Equation (26A) are selected such that the same noise reduction rate R is achieved from the multiplication noise suppression and spectral subtraction, it is understood from FIG. 3 that the multiplication noise suppression has a tendency to limit the kurtosis index κ to a small value as compared to the spectral subtraction. That is, the multiplication noise suppression is more advantageous than the spectral subtraction in terms of compatibility of improvement in the noise reduction rate R with reduction in the musical noise.

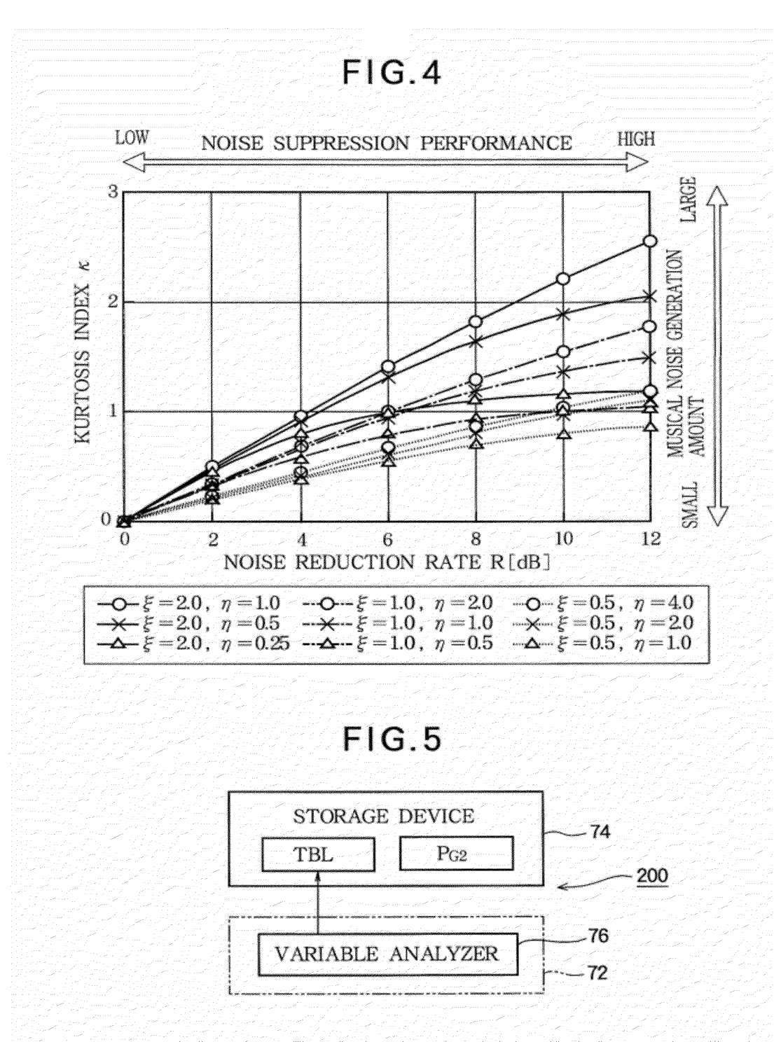

FIG. 4 is a graph showing a relationship between the kurtosis index κ and noise reduction rate R for a plurality of cases in which the signal exponent ξ and the gain exponent η of Equation (3) applied to the multiplication noise suppression are varied. FIG. 4 shows a relationship between the kurtosis index κ and noise reduction rate R for a plurality of cases in which the gain exponent η is varied (η=2.0/ξ, 1.0/ξ, 0.5/ξ) for values of the signal exponent ξ(ξ=2.0, 1.0, 0.5). Combinations of values of the signal exponent ξ and the gain exponent η are as follows.
(1) Solid line (ξ=2.0): 2.0 multiple of and |X(f,τ)| and |N(f,τ)| (power domain)
◯ (η=1.0): 1.0 multiple of the basic value b(f, τ) (maintain power domain)
× (η=0.5): 0.5 multiple of the basic value b(f, τ) (change to amplitude domain)
Δ (η=0.25): 0.25 multiple of the basic value b(f, τ) (change to root domain)
(2) Dot-dashed line (ξ=1.0): 1.0 multiple of |X(f,τ)| and |N(f,τ)| (amplitude domain)
◯ (η=2.0): 2,0 multiple of the basic value b(f, τ) (change to power domain)
× (η=1.0): 1.0 multiple of the basic value b(f, τ) (maintain amplitude domain)
Δ (η=0.5): 0.5 multiple of the basic value b(f, τ) (change to root domain)
(3) Dashed line (ξ=0.5): 0.5 multiple of |X(f,τ)| and |N(f,τ)| (root domain)
◯ (η=4.0): 4.0 multiple of the basic value b(f, τ) (change to power domain)
× (η=2.0): 2.0 multiple of the basic value b(f, τ) (change to amplitude domain)
Δ (η=1.0): 1.0 multiple of the basic value b(f, τ) (maintain root domain)

As is known from FIGS. 3 and 4, a degree by which the kurtosis index κ is reduced (musical noise is suppressed) and a degree by which the noise reduction rate R (noise suppression capability) is improved become higher as the signal exponent ξ decreases. Furthermore, it is known from FIG. 4 that reduction in the kurtosis index κ and improvement in the noise reduction rate R are compatible with each other to a higher degree as the gain exponent η decreases for the same signal exponent ξ. For example, compatibility of reduction in the kurtosis index κ with improvement in the noise reduction rate R (noise suppression performance) is maximized when the signal exponent ξ is set to 0.5 and the gain exponent η is set to 1.0 (a combination of broken line and “Δ”) from among nine combinations shown in FIG. 4.

In view of the above tendency, the signal exponent ξ and the gain exponent η applied to Equation (3) are set to small values (for example, positive numbers smaller than 1). For example, the signal exponent ξ is set to a value smaller than 1 and the gain exponent η is set to a value different from the signal exponent ξ. More preferably, the signal exponent ξ is set to a value equal to or smaller than 0.5 (for example, 0.2). In terms of calculation performance (accuracy), at least one of the signal exponent ξ and the gain exponent η is set to a minimum value within a range in which the arithmetic processing device 22 can calculate the coefficient value g(f, τ) of Equation (3) with a predetermined degree of accuracy (for example, a range in which the arithmetic processing device 22 obtains a significant value by avoiding underflow on the basis of computable floating points). Results of analysis of the noise reduction rate R and the kurtosis index κ are as described above.

<Generation of Variable Table TBL>
The variable table TBL shown in FIG. 2 is created using the above-mentioned analysis results (Equation (22) and Equation (25)). FIG. 5 is a block diagram of a noise suppression analysis apparatus 200 that creates the variable table TBL. The noise suppression analysis apparatus 200 is implemented as a computer system including an arithmetic processing device 72 and a storage device 74 as is the audio processing apparatus 100. The arithmetic processing device 72 functions as a variable analyzer 76 according to execution of a program PG2 stored in the storage device 74. The variable analyzer 76 creates the variable table TBL used in the audio processing apparatus 100. It is possible to employ a configuration in which the arithmetic processing device 22 of the audio processing apparatus 100 functions as the variable analyzer 76.

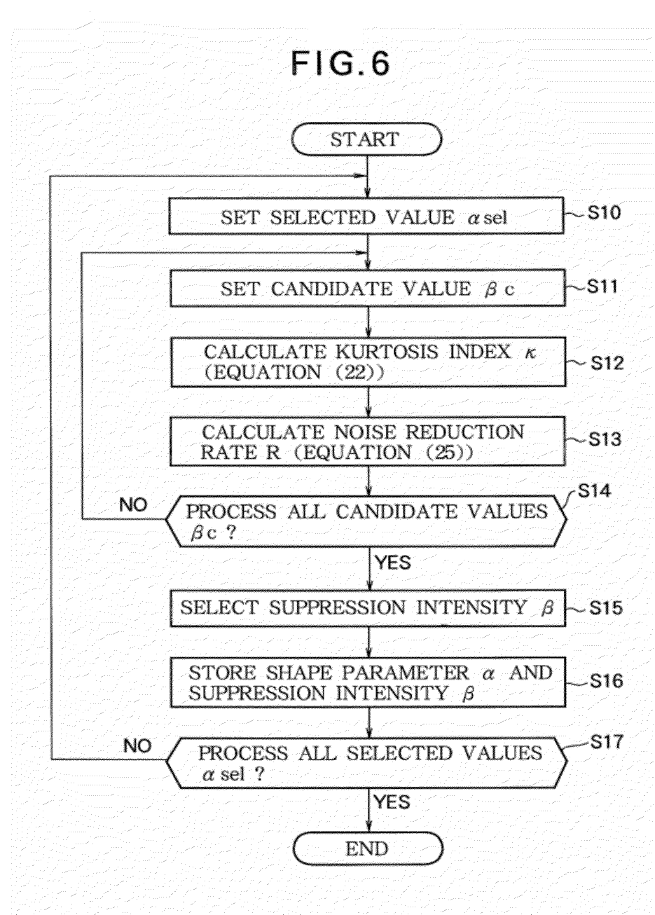

FIG. 6 is a flowchart illustrating an operation of the variable analyzer 76. The operation shown in FIG. 6 is performed based on an instruction from the user for the noise suppression analysis apparatus 200 (instruction to create the variable table TBL). Processes S10-S16 for determining a suppression intensity β most suitable for noise suppression for the audio signal Sx(t) having a shape parameter α corresponding to a value αsel are sequentially performed for each of a plurality of values αsel considered as the shape parameter α.

When the procedure of FIG. 6 is initiated, the variable analyzer 76 selects one (hereinafter referred to as a selected value) αsel of the plurality of values considered as the shape parameter α (S10). The selected value αsel is renewed whenever process S10 is performed. For example, the selected value αsel is set to each of values varied in predetermined increments (for example, 2) in a range (for example, 3≦αsel≦101) of values considered as the shape parameter α of the audio signal Sx(t).

The variable analyzer 76 sets a candidate value βc of the suppression intensity β(S11). The candidate value βc is renewed whenever process S11 is performed. For example, the candidate value βc is set to each of values varied in predetermined increments (for example, δc=0.1) in a predetermined range Ac (for example, 1≦βc≦3).

The variable analyzer 76 calculates the kurtosis index κ through Equation (22) having the selected value αsel selected in process S10 as the shape parameter α and having the candidate value βc set in process S11 as the suppression intensity β(S12). In addition, the variable analyzer 76 calculates the noise reduction rate R through Equation (25) having the selected value αsel as the shape parameter α and having the candidate value βc as the suppression intensity β (S13). The signal exponent ξ and the gain exponent η of Equation (22) and Equation (25) are set to values depending on the calculation capability of the audio processing apparatus 100 considered to use the variable table TBL.

The variable analyzer 76 determines whether or not the kurtosis indexes κ and noise reduction rates R have been calculated for all candidate values βc considered as values of the suppression intensity β(S14). If the variable analyzer 76 determines that the kurtosis indexes κ and noise reduction rates R have not been calculated for all candidate values βc in process S14, the variable analyzer 76 renews the candidate value βc (S11), calculates the kurtosis index κ for the renewed candidate value βc (S12), and calculates the noise reduction rate R for the renewed candidate value βc (S13). That is, the kurtosis index κ and the noise reduction rate R are calculated for every candidate value βc in the range Ac.

Upon completion of calculation of the kurtosis indexes κ and the noise reduction rates R for all candidate values βc (S14: YES), the variable analyzer 76 selects a candidate value βc most suitable for noise suppression for the audio signal Sx(t) which has a current selected value αsel as the shape parameter α from a plurality of candidate values βc in the range Ac based on the kurtosis index κ and the noise reduction rate R for each candidate value βc (S15). Specifically, the variable analyzer 76 selects a candidate value βc that satisfies both a condition (κ<κtar) that the kurtosis index κ is smaller than a predetermined allowable value κtar and a condition (R>Rtar) that the noise reduction rate R exceeds a target value Rtar. If a plurality of candidate values βc satisfy the conditions, the variable analyzer 76 selects a candidate value βc corresponding to a minimum kurtosis index κ or a candidate value βc corresponding to a maximum noise reduction rate R. The allowable value κtar and the target value Rtar are previously set depending on the use and specifications (a degree by which musical noise reduction and noise suppression performance are required) of the audio processing apparatus 100.

The variable analyzer 76 matches the shape parameter α corresponding to the current selected value αsel to the suppression intensity β corresponding to the candidate value βc selected in process S15, and then stores them in the storage device 74 (S16). In addition, the variable analyzer 76 determines whether or not values of the suppression intensity β haven been specified for all selected values αsel (S17). If the variable analyzer 76 determines that the values of the suppression intensity β have not been calculated for all selected values αsel in process S17, the variable analyzer 76 renews the selected value αsel (S10), and selects a value of the suppression intensity β for the renewed selected value αsel (S11 to S16). If the values of the suppression intensity β have been specified for all selected values αsel considered as the shape parameter α (S17: YES), the variable analyzer 76 finishes the procedure of FIG. 6. Upon completion of the procedure of FIG. 6, the variable table TBL in which values of the suppression intensity β respectively correspond to values (selected values αsel) of the shape parameters a is generated in the storage device 74.

The variable table TBL generated by the variable analyzer 76 is transmitted to the storage device 24 of the audio processing apparatus 100 and applied to noise suppression for the sound signal Sx(t). As is understood from the above explanation, the intensity setting unit 48 uses a suppression intensity β selected from the variable table TBL depending on the shape parameter α, and thus it is possible to achieve noise suppression that allows the noise reduction rate R to exceed the target value Rtar and allows the kurtosis index κ to be lower than the allowable value κtar. That is, it is possible to achieve compatibility of improvement in the noise reduction rate R with reduction in the musical noise.

### B: Second Embodiment

A second embodiment of the invention is described below. In each embodiment illustrated below, elements whose operations or functions are similar to those of the first embodiment will be denoted by the same reference numerals as used in the above description and a detailed description thereof will be omitted as appropriate.

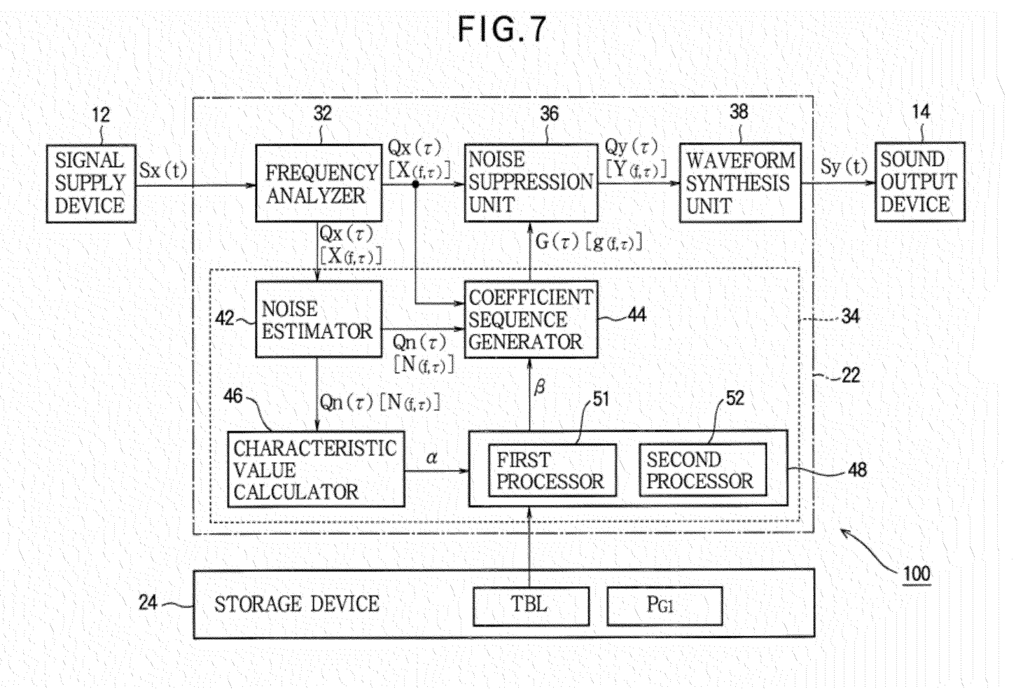

FIG. 7 is a block diagram of an audio processing apparatus 100 according to the second embodiment of the invention. As shown in FIG. 7, the intensity setting unit 48 of the audio processing apparatus 100 according to the second embodiment includes a first processor 51 and a second processor 52. The first processor 51 specifies a suppression intensity βT (the suppression intensity β of the first embodiment) corresponding to a shape parameter α calculated by the characteristic value calculator 46 from the variable table TBL as does the intensity processor 48 of the first embodiment of the invention. The second processor 52 sets a decided suppression intensity β using the suppression intensity βT specified by the first processor 51. The suppression intensity β set by the second processor 52 is applied when the coefficient sequence generator 44 generates (Equation (3)) the suppression coefficient sequence G(τ).

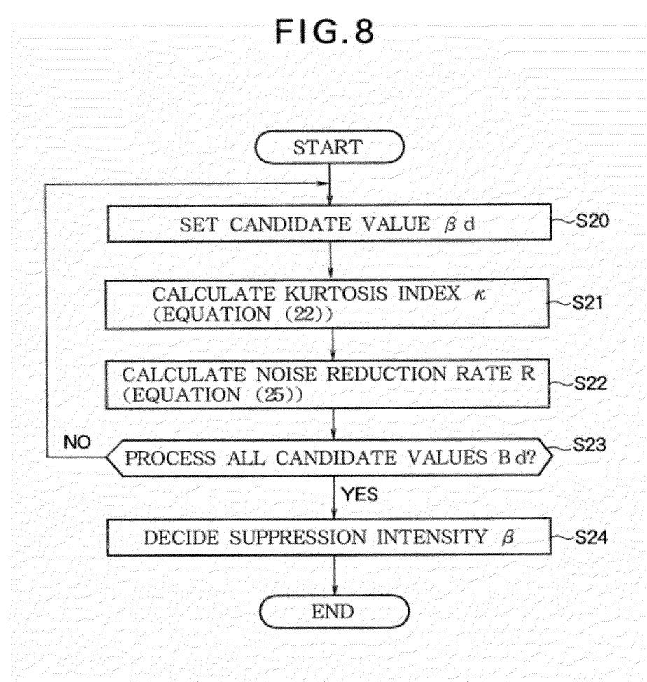

FIG. 8 is a flowchart illustrating an operation of the second processor 52. The operation shown in FIG. 8 is performed upon decision of the suppression intensity βT according to the first processor 51. When the procedure of FIG. 8 is initiated, the second processor 52 sets a candidate value βd of the suppression intensity β(S20). The candidate value βd is renewed whenever process S20 is performed. Specifically, the candidate value βd is set to each of values varied in predetermined increments δd within a predetermined range Ad including the suppression intensity βT specified by the first processor 51. The range Ad is set to a range with a predetermined width having the suppression intensity βT at the center, for example. The range Ad of the candidate values βd is narrower than the range Ac of the candidate values βc set in process S11 of FIG. 6, and the increment δd of the candidate values βd is less than the increment δc of the candidate values βc set in process S11 (for example, δd=δc/4).

The second processor 52 calculates a kurtosis index κ through Equation (22) to which a shape parameter α calculated by the characteristic value calculator 46 and the candidate value βd (suppression intensity β of Equation (22)) set in S20 are applied (S21). Similarly, the second processor 52 calculates a noise reduction rate R through Equation (25) to which the shape parameter a and the candidate value βd are applied (S22). In addition, the second processor 52 determines whether or not the kurtosis indexes κ and noise reduction rates R have been calculated for all candidate values βd within the range Ad (S23). If the second processor 52 determines that the kurtosis indexes κ and noise reduction rates R have not been calculated for all candidate values βd in process S23, the second processor 52 renews the candidate value βd, calculates a kurtosis indexes κ for the renewed candidate value βd (S21), and calculates a noise reduction rate R for the renewed candidate value βd (S22). That is, the kurtosis index κ and noise reduction rate R are calculated for each candidate value βd within the range Ad.

Upon calculation of values of the kurtosis index κ and noise reduction rates R for all candidate values βd (S23: YES), the second processor 52 selects a candidate value βd corresponding to an optimized kurtosis index κ and an optimized noise reduction rate R as a decided suppression intensity β from the plurality of candidate values βd (S24). For example, the second processor 52 calculates similarity λ (for example, distance and inner product) of a vector V having the kurtosis index κ and noise reduction rate R as elements and a vector Vtar having the allowable value κtar and target value Rtar as elements for each candidate value βd, and decides a candidate value βd corresponding to the vector V having highest similarity as a suppression intensity β. That is, in noise suppression for the audio signal Sx(t) of the shape parameter α, a suppression intensity β that can achieve compatibility of reduction in the kurtosis index κ (reduction in musical noise) with improvement in the noise reduction rate R is decided.

The second embodiment of the invention achieves the same effect as that of the first embodiment of the invention. In the second embodiment of the invention, a candidate value βd corresponding to an optimized kurtosis index κ and an optimized noise reduction rate R from among a plurality of candidate values βd within the range Ad including a suppression intensity βT selected from the variable table TBL is used as a decided suppression intensity β to generate the suppression coefficient sequence G(τ). In addition, the increment δd of the candidate values βd set by the second processor 52 is narrower than the increment δc of the candidate values βc of the suppression intensity β when the variable table TBL is created. Accordingly, it is possible to set the suppression intensity β to a more suitable value as compared to the first embodiment in which the suppression intensity β in the variable table TBL is indicated to the coefficient sequence generator 44. That is, compatibility of effective noise suppression with musical noise reduction is improved.

### C: Third Embodiment

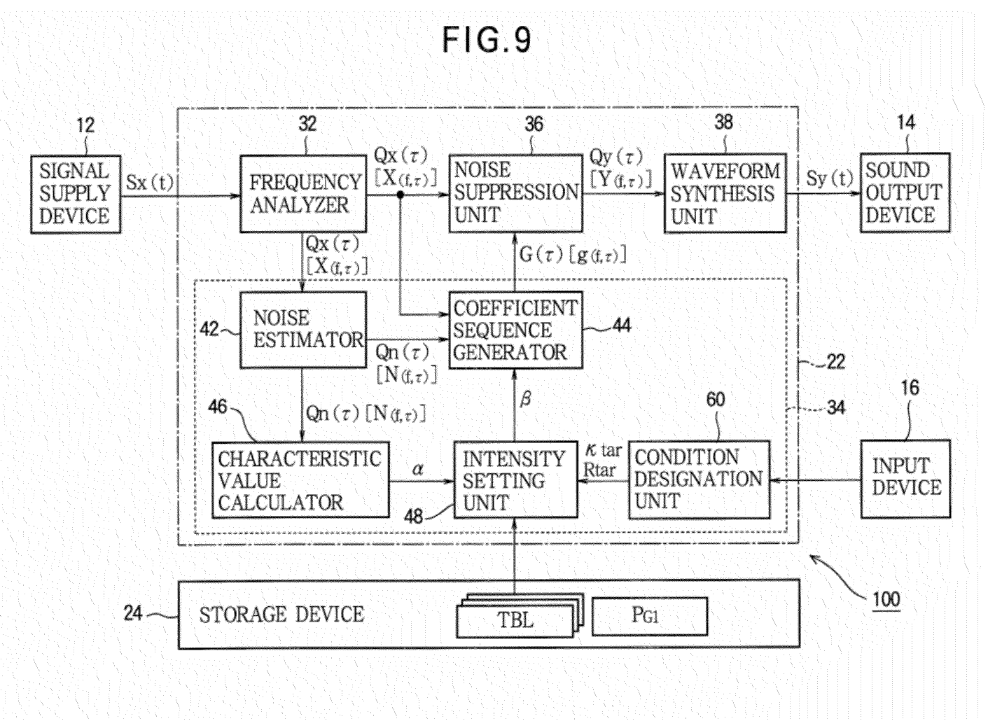

FIG. 9 is a block diagram of an audio processing apparatus 100 according to a third embodiment of the invention. As shown in FIG. 9, an input device 16 receiving instructions from the user is connected to the audio processing apparatus 100. An analysis processor 34 of the third embodiment includes a condition designation unit 60 in addition to the components of that of the first embodiment. The condition designation unit 60 variably sets an allowable value κtar of the kurtosis index κ and a target value Rtar of the noise reduction rate R. For example, the condition designation unit 60 sets the allowable value κtar and the target value Rtar based on an instruction from the user through the input device 16.

As shown in FIG. 9, the storage device 24 stores a plurality of variable tables TBL. The variable tables TBL have different combinations of allowable values κtar and target values Rtar applied when the variable tables TBL are generated. That is, the noise suppression analysis apparatus 200 (variable analyzer 76) performs the procedure of FIG. 6 on each of the combinations of allowable values κtar and target values Rtar to generate each of the variable tables TBL.

The intensity setting unit 48 selects a variable table TBL corresponding to a combination of an allowable value κtar and target value Rtar designated by the condition designation unit 60 from the plurality of variable tables TBL stored in the storage device 24, searches the selected variable table TBL for a suppression intensity β corresponding to the shape parameter α calculated by the characteristic value calculator 46, and informs the coefficient sequence generator 44 of the suppression intensity β.

In other words, a suppression intensity β of noise suppression is selected such that a kurtosis index κ when the noise suppression unit 36 executes noise suppression is lower than the allowable value αtar designated by the condition designation unit 60 and a noise reduction rate R when the noise suppression unit 36 performs noise suppression exceeds the target value Rtar designated by the condition designation unit 60. For example, musical noise of the audio signal Sy(t) after noise suppression decreases as the allowable value κtar designated by the condition designation unit 60 decreases, and suppression of the noise component n(t) is reinforced as the target value Rtar designated by the condition designation unit 60 increases. As is understood from the above description, the condition designation unit 60 functions as a component that designates a condition required for noise suppression for the audio signal Sx(t).

The third embodiment achieves the same effect as that of the first embodiment. In the third embodiment of the invention, the suppression intensity β is variably set depending on the allowable value κtar and target value Rtar designated by the condition designation unit 60, and thus noise suppression performance and a degree by which musical noise is reduced can be adjusted depending on the use of the audio processing apparatus 100 and a request of the user. Furthermore, the configuration of the third embodiment in which the suppression intensity β is variably set depending on the allowable value κtar and target value Rtar can be applied to the second embodiment.

### D: Fourth Embodiment

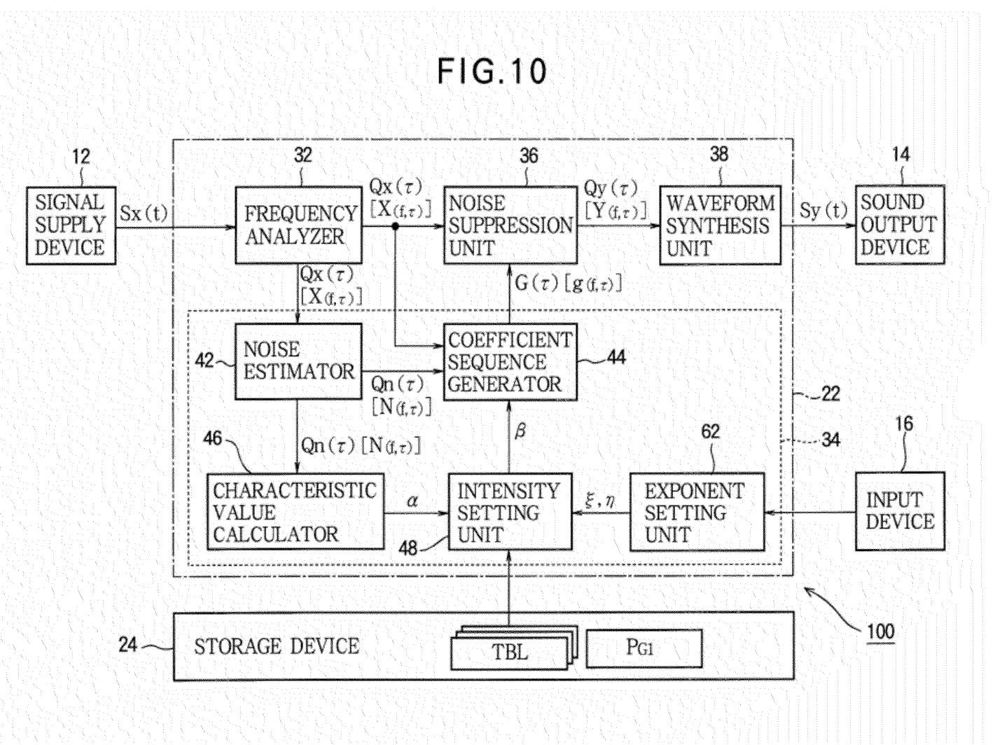

FIG. 10 is a block diagram of an audio processing apparatus 100 according to a fourth embodiment of the invention. The audio processing apparatus 100 according to the fourth embodiment of the invention includes an exponent setting unit 62 that substitutes the condition designation unit 60 of the third embodiments (FIG. 9). The exponent setting unit 62 variably sets the signal exponent ξ and the gain exponent η of Equation (3). Specifically, the exponent setting unit 62 sets the signal exponent ξ and the gain exponent η according to manipulation of the input device 16. For example, the user instructs the signal exponent ξ and the gain exponent η to be set through the input device 16 depending on the calculation capability of the arithmetic processing device 22. It is possible to employ a configuration in which the exponent setting unit 62 automatically sets the signal exponent ξ and the gain exponent η depending on the calculation capability of the arithmetic processing device 22 (that is, a configuration that does not require an instruction from the user). As described above, the signal exponent ξ and the gain exponent η are set to, for example, a value smaller than 1 within the range of the calculation capability of the arithmetic processing device 22, and more desirably, set to a value equal to or smaller than 0.5 (for example, 0.2).

The storage device 24 stores a plurality of variable tables TBL. The variable tables TBL have different combinations of values of the signal exponent ξ and the gain exponent η applied to calculations of Equation (22) and Equation (25) when the variable tables TBL are generated. The intensity setting unit 48 selects a variable table TBL corresponding to the signal exponent ξ and gain exponent η designated by the exponent setting unit 62 from the plurality of variable tables TBL stored in the storage device 24, searches the selected variable table TBL for a suppression intensity β corresponding to the shape parameter α calculated by the characteristic value calculator 46, and informs the coefficient sequence generator 44 of the suppression intensity β. Accordingly, the suppression intensity β (that is, the suppression intensity β that makes the noise reduction rate R exceed the target value Rtar and makes the kurtosis index κ be lower than the allowable value κtar) most suitable for noise suppression of Equation (2) obtained by applying the signal exponent ξ and the gain exponent η designated by the exponent setting unit 62 to Equation (3) is applied to generation of the suppression coefficient sequence G(τ).

The fourth embodiment of the invention achieves the same effect as that of the first embodiment of the invention. In the fourth embodiment of the invention, the suppression intensity β is variably set depending on the signal exponent ξ and the gain exponent η designated by the exponent setting unit 62, and thus a suppression intensity β suitable to achieve compatibility of effective noise suppression with musical noise reduction can be selected in the limit of the calculation capability of the arithmetic processing device 22. Furthermore, the configuration of the fourth embodiment in which the suppression intensity β is variably set depending on the signal exponent ξ and the gain exponent η can be applied to the second embodiment and the third embodiment of the invention.

### E: Modifications

Various modifications can be made to each of the above embodiments. The following are specific examples of such modifications. Two or more modifications arbitrarily selected from the following examples may be appropriately combined.

(1) Modification 1

While the shape parameter a of the probability density function P(x) that approximates the magnitude distribution of the audio signal Sx(t) is exemplified as a characteristic index (noise characteristic value) of the noise component n(t) in the above embodiments, the noise characteristic value is not limited to the shape parameter. For example, a statistic (for example, a high order statistic such as kurtosis, etc.) which is calculated directly (that is, which does not require approximation) from the magnitude distribution of the audio signal Sx(t) and a statistic (for example, a shape parameter of a probability density function that approximates the frequency distribution of the amplitude |X(f,τ)|) depending on the frequency distribution of the amplitude |X(f,τ)| of the audio signal Sx(t) can be also used as the noise characteristic value. That is, the noise characteristic value is included in values (typically values depending on the shape of a magnitude distribution) varied with the characteristic (particularly, characteristic of the noise component n(t)) of the audio signal Sx(t).

(2) Modification 2

While the variable table TBL is used to set the suppression intensity β in the above embodiments, use of the variable table TBL may be omitted. For example, it is possible to employ a configuration in which the intensity setting unit 48 calculates a most suitable suppression intensity β based on a shape parameter α by solving Equation (22) and Equation (25). Specifically, the intensity setting unit 48 calculates the kurtosis index κ and noise reduction rate R through Equation (22) and Equation (25) to which the shape parameter α is applied while sequentially varying the suppression intensity β within a predetermined range, and informs the coefficient sequence generator 44 of a suppression intensity β corresponding to a combination of an optimized kurtosis index κ and an optimized noise reduction rate R, as described in the second embodiment. According to the above configuration, capacity required for the storage device 24 is reduced. Furthermore, according to the configuration using the variable table TBL, a processing load of the intensity setting unit 48 is alleviated as compared to the configuration of calculating the suppression intensity β using arithmetic processing.

(3) Modification 3

While the suppression coefficient sequence G(τ) is generated for each unit interval in the above embodiments, a suppression coefficient sequence generation cycle may be appropriately changed. For example, in view of a tendency that the characteristic of the audio signal Sx(t) is approximated in unit intervals before and after a phase, it is possible to employ a configuration in which the suppression coefficient sequence G(τ) is generated at an interval corresponding to a plurality of phase-continuous unit intervals, and the suppression coefficient sequence for each interval is commonly applied to the audio signal Sx(t) of unit intervals in the corresponding interval. Furthermore, although the suppression coefficient sequence G(τ) for each unit interval is applied to the audio signal Sx(t) of the unit interval in the above embodiments, it is possible to employ a configuration in which a unit interval of the audio signal Sx(t) used to generate the suppression coefficient sequence G(τ) differs from a unit interval to which the suppression coefficient sequence G(τ) is applied. For example, it is possible to employ a configuration in which the suppression coefficient sequence G(τ) generated from each unit interval of the sound signal Sx(t) is applied to a unit interval after the unit interval (for example, immediately after the unit interval).

(4) Modification 4

Although the audio processing apparatus 100 and the noise suppression analysis apparatus 200 are separated from each other in the above embodiments, the function (the variable analyzer 76 generating the variable table TBL) of the noise suppression analysis apparatus 200 may be mounted in the audio processing apparatus 100.

(5) Modification 5

Although the suppression intensity β is set such that both the kurtosis index κ and noise reduction rate R satisfy a predetermined condition in the above embodiments, the suppression intensity β may be set such that one of the kurtosis index κ and noise reduction rate R satisfies the predetermined condition.

What is claimed is:

1. An audio processing apparatus for generating a suppression coefficient sequence that is used for noise reduction of an audio signal and that is composed of coefficient values corresponding to frequency components of the audio signal, the frequency components being multiplied by the corresponding coefficient values to suppress noise components of the audio signal, the audio processing apparatus comprising:
a characteristic value calculation unit that calculates a noise characteristic value depending on a shape of a magnitude distribution of the audio signal;
an intensity setting unit that variably sets a suppression intensity of the noise components based on the noise characteristic value; and
a coefficient sequence generation unit that generates the suppression coefficient sequence based on the audio signal and the suppression intensity.

2. The audio processing apparatus according to claim 1, wherein the intensity setting unit sets the suppression intensity such that a rate of the noise reduction achieved by applying the suppression coefficient sequence to the audio signal exceeds a target value and such that a kurtosis index representing a degree of variation in kurtosis of the magnitude distribution of the audio signal before and after the noise reduction is lower than an allowable value.

3. The audio processing apparatus according to claim 2, further comprising a condition designation unit that variably sets the target value of the rate of the noise reduction and the allowable value of the kurtosis index.

4. The audio processing apparatus according to claim 2, wherein the intensity setting unit sets a plurality of candidates of the suppression intensity, then calculates a vector composed of the rate of the noise reduction and the kurtosis index for each candidate of the suppression intensity, further calculates a similarity between each vector of each candidate and a reference vector composed of the target value of the rate of the noise reduction and the allowable value of the kurtosis index, and sets a candidate having a maximum similarity to the the suppression intensity among the plurality of the candidates of the suppression intensity.

5. The audio processing apparatus according to claim 1, wherein
the coefficient sequence generation unit calculates each coefficient value g(f) of the suppression coefficient sequence corresponding to each frequency f of the frequency components of the audio signal using the following equation containing an amplitude |X(f)| at a corresponding frequency f of the audio signal, the suppression intensity β set by the intensity setting unit, and an estimated amplitude |N(f)| at the corresponding frequency f of the noise component of the audio signal, and wherein
the audio processing apparatus further comprises an exponent setting unit that variably sets a signal exponent ξ and a gain exponent η contained in the following equation:
g(f)={|X(f)|^{ξ}/(|X(f)|^{ξ}+β·Et[|N(f)|^{ξ}])}^{η}
where a symbol Et[ ] denotes a time average, and the signal exponent ξ and the gain exponent η are positive numbers.

6. The audio processing apparatus according to claim 5, wherein the exponent setting unit sets the signal exponent ξ to a positive number smaller than 1 and sets the gain exponent η to a value different from the signal exponent ξ.

7. The audio processing apparatus according to claim 5, wherein the exponent setting unit sets one of the signal exponent ξ and the gain exponent η to a minimum value within a range of calculation capability of the audio processing apparatus.

8. An audio processing apparatus for generating a suppression coefficient sequence that is composed of coefficient values corresponding to frequency components of an audio signal, the frequency components being multiplied by the corresponding coefficient values so as to suppress noise components of the audio signal, the audio processing apparatus comprising:
a noise estimation unit that estimates the noise components of the audio signal;
a coefficient sequence generation unit that calculates each coefficient value g(f) of the suppression coefficient sequence corresponding to each frequency f of the frequency components of the audio signal using the following equation
g(f)={|X(f)|^{ξ}/(|X(f)|^{ξ}+β·Et[|N(f)|^{ξ}])}^{η}
where |X(f)| denotes an amplitude at a corresponding frequency f of the audio signal, |N(f)| denotes an estimated amplitude at the corresponding frequency f of the estimated noise component of the audio signal, Et[ ] denotes a time average, β denotes a suppression intensity, ξ denotes a signal exponent of a positive number, and η denotes a gain exponent of a positive number; and
an exponent setting unit that sets the signal exponent ξ and the gain exponent η to different numbers.

9. The audio processing apparatus according to claim 8, wherein the exponent setting unit sets at least one of the signal exponent ξ and the gain exponent η to a value smaller than 1.

10. The audio processing apparatus according to claim 8, wherein the exponent setting unit sets one of the signal exponent ξ and the gain exponent η to a minimum value within a range of calculation capability of the audio processing apparatus.

11. A machine readable storage medium for use in a computer, the storage medium containing program instructions executable by the computer to perform audio processing of generating a suppression coefficient sequence that is composed of coefficient values corresponding to frequency components of an audio signal, the frequency components being multiplied by the corresponding coefficient values so as to suppress noise components of the audio signal, wherein the audio processing comprises:
a characteristic value calculation process of calculating a noise characteristic value depending on a shape of a magnitude distribution of the audio signal;
an intensity setting process of variably setting a suppression intensity of the noise components based on the noise characteristic value; and
a coefficient sequence generation process of generating the suppression coefficient sequence based on the audio signal and the suppression intensity.

12. A machine readable storage medium for use in a computer, the storage medium containing program instructions executable by the computer to perform audio processing of generating a suppression coefficient sequence that is composed of coefficient values corresponding to frequency components of an audio signal, the frequency components being multiplied by the corresponding coefficient values so as to suppress noise components of the audio signal, wherein the audio processing comprises:
a noise estimation process of estimating the noise components of the audio signal;
a coefficient sequence generation process of calculating each coefficient value g(f) of the suppression coefficient sequence corresponding to each frequency f of the frequency components of the audio signal using the following equation
g(f)={|X(f)|^{ξ}/(|X(f)|^{ξ}+β·Et[|N(f)|^{ξ}])}^{η}
where |X(f)| denotes an amplitude at a corresponding frequency f of the audio signal, |N(f)| denotes an estimated amplitude at the corresponding frequency f of the estimated noise component of the audio signal, Et[ ] denotes a time average, β denotes a suppression intensity, ξ denotes a signal exponent of a positive number, and η denotes a gain exponent of a positive number; and
an exponent setting process of setting the signal exponent ξ and the gain exponent η to different numbers.
